(19) United States
(12) Patent Application Publication
(10) Pub. No.: US 2009/0117332 A1
(43) Pub. Date: May 7, 2009

(54) MONOLITHIC GLASS ARRAY

(75) Inventors: Jason Ellsworth, Mesa, AZ (US); Darrel Bailey, Gilbert, AZ (US)

Correspondence Address: THE MUELLER LAW OFFICE, P.C., 12951 Harwick Lane, San Diego, CA, 92130, US

(73) Assignee: SolFocus, Inc., Mountain View, CA (US)

(21) Appl. No.: 12/044,939

(22) Filed: Mar. 8, 2008

Related U.S. Application Data
(60) Provisional application No. 60/985,215, filed on Nov. 3, 2007.

(51) Int. Cl. C03B 23/035; C03B 25/12; F24J 2/10

(52) U.S. Cl. 428/156; 65/104; 65/287; 126/684

(57) ABSTRACT

The present invention is an apparatus and process for forming a monolithic array of glass parts. This invention enables high-precision glass parts of a relatively large size, such as mirrors for a solar concentrator, to be manufactured in an economical manner. A multi-cavity mold prevents warping of a glass sheet during a slumping process by utilizing multiple vacuum ports, which may be supplemented by stiffening features formed in the mold.

### RELATED APPLICATIONS

This application claims priority to U.S. Provisional Patent Application Ser. No. 60/985,215 filed on Nov. 3, 2007 entitled “Monolithic Mirror Array,” which is hereby incorporated by reference as if set forth in full in this application for all purposes.

### BACKGROUND OF THE INVENTION

Solar energy generation is an important and growing area in the field of environmentally friendly energy production. Conversion of solar energy into electricity is commonly seen in the form of flat panel technology, in which solar radiation impinges directly on large arrays of photovoltaic cells. However, a more efficient method of producing solar energy, solar concentration, has been rapidly developing. Solar concentrators utilize mirrors and lenses to concentrate light from a relatively large area onto a small photovoltaic cell. For example, the solar cell size in a solar concentrator may be less than 1% of the entry window surface area, rather than having solar cells covering an entire window as in flat panel technology. The cost reduction resulting from the greatly reduced amount of expensive photovoltaic material makes solar concentrators a very desirable method of energy production. Moreover, the efficiency of energy conversion is increased due to the highly concentrated light impacting the solar cell. To generate energy at a commercial level, solar concentrators are typically assembled into arrays composed of many individual units.

Solar concentrators depend heavily on the ability of their optical components to accurately focus light on a small surface area. Optical components can include curved mirrors formed to a prescribed profile from glass, such as by slumping. Slumping involves laying a flat sheet of glass onto a mold and heating the glass so that it softens. The weight of the glass causes it to slump into the mold and take the shape of the mold. Vacuum pressure is sometimes applied from within the mold cavity to assist the glass in conforming to the shape of the mold. While slumping molds may be made with high precision, their use has primarily been limited to single cavity molds. Because parts are produced only one at a time, high-precision production of glass, particularly for glass parts larger than a few square inches in size, remains a slow and costly process. Current processes for high-volume glass production, such as for manufacturing lighting fixtures or sunglasses, do not have the level of precision or ability to address sizes required for mirrors used in solar concentrators.

Thus, as the demand for solar concentrator arrays continues to grow, there is a new need to manufacture precision-formed glass components, especially for those of a relatively large size, at greater volumes and at commercially feasible costs. A glass forming process which can achieve high precision and high throughput and which can additionally provide manufacturing benefits, such as features beneficial to downstream assembly steps, provides even further advantages.

### SUMMARY OF THE INVENTION

The present invention is an apparatus and process for forming a monolithic array of glass parts. This invention enables high-precision glass parts of a relatively large size, such as mirrors for a solar concentrator, to be manufactured in an economical manner. A multi-cavity mold prevents warping of a glass sheet during a slumping process by utilizing multiple vacuum ports, which may be supplemented by stiffening features formed in the mold. In one embodiment, a vacuum channel holds the peripheries of a glass sheet in place while the glass is being drawn into the cavities of the mold. The invention allows glass parts to be monolithically fabricated as partial or full arrays.

### BRIEF DESCRIPTION OF THE DRAWINGS

FIG. 1 is a perspective view of an exemplary glass mirror;

FIG. 2 provides an exploded perspective view of exemplary components for forming glass according to the present invention;

FIG. 3A is a plan view of the exemplary mold of FIG. 2;

FIG. 3B shows a sectional view of the mold of FIG. 3A;

FIG. 3C shows a further sectional view of the mold of FIG. 3A;

FIG. 4A provides a plan view of an exemplary base for the mold of FIG. 3A;

FIG. 4B is a sectional view of the base of FIG. 4A;

FIG. 5 shows the sectional views of FIGS. 3B and 4B assembled together;

FIG. 6 depicts a plan view of another embodiment of a mold;

FIG. 7A illustrates a perspective view of a glass array produced from the mold of FIG. 6;

FIG. 7B provides a perspective view of partial array cut from the glass array of FIG. 7A;

FIG. 8 depicts another embodiment of a base for a mold;

FIG. 9 is a perspective view of the base from FIG. 8;

FIG. 10 shows yet another embodiment of a mold of the present invention; and

FIG. 11 illustrates an exemplary process for forming a monolithic glass array.

### DETAILED DESCRIPTION OF THE EMBODIMENTS

Reference now will be made in detail to embodiments of the disclosed invention, one or more examples of which are illustrated in the accompanying drawings.

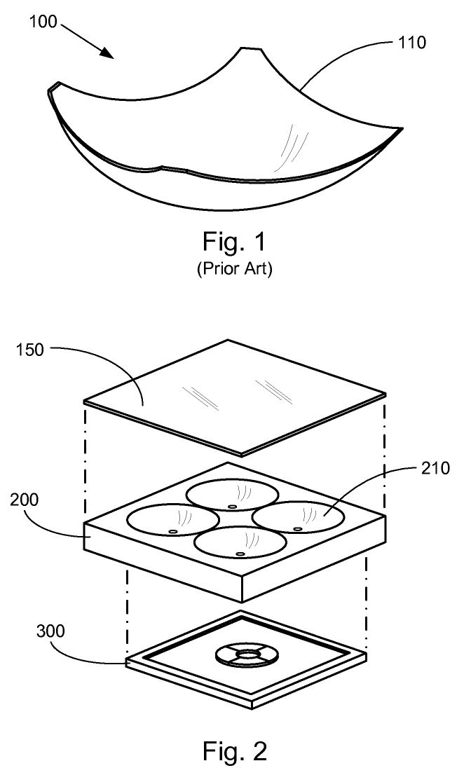

In solar concentrators, various types of flat and curved mirrors have been used to concentrate light. The perspective view of FIG. 1 depicts an exemplary curved mirror 100, which typically has a precisely defined curvature to achieve the desired optical characteristics for a specific concentrator design. Truncated sides 110 result in mirror 100 having a substantially square perimeter, which is beneficial for packaging multiple mirrors 100 into a solar concentrator array. To encompass a sufficient surface area for collecting solar radiation, mirror 100 may have a diameter on the order of, for example, more than 10 inches and a depth on the order of, for example, more than 2 inches. Techniques for slumping glass of this size and precision have currently only been developed for single cavity molds, and thus such mirrors are costly for commercial production requiring arrays of many mirrors.

FIG. 2 depicts an exploded perspective view of exemplary components of the present invention, in which multiple glass parts may be produced simultaneously. In FIG. 2 a glass sheet 150 is placed onto a multi-cavity mold 200, which can optionally mate with a base 300. The exemplary mold 200 has four cavities 210, enabling four parts, such as mirrors, to be fabricated at one time. Individual mirrors shaped by this mold may subsequently undergo further processing, such as cutting of the truncated sides 110 of FIG. 1. Alternatively, mirrors produced by mold 200 may remain connected and advantageously be used as a single monolithic array or as partial arrays. When the glass sheet 150, mold 200, and base 300 are heated to a sufficient temperature, glass sheet 150 softens and the weight of the glass causes it to sag into the cavities 210. With current slumping methods, glass sheets with surface areas greater than approximately one square foot result in warping and consequently inaccurate formation of parts. The current invention overcomes this issue through features which prevent warping, as will now be described in more detail.

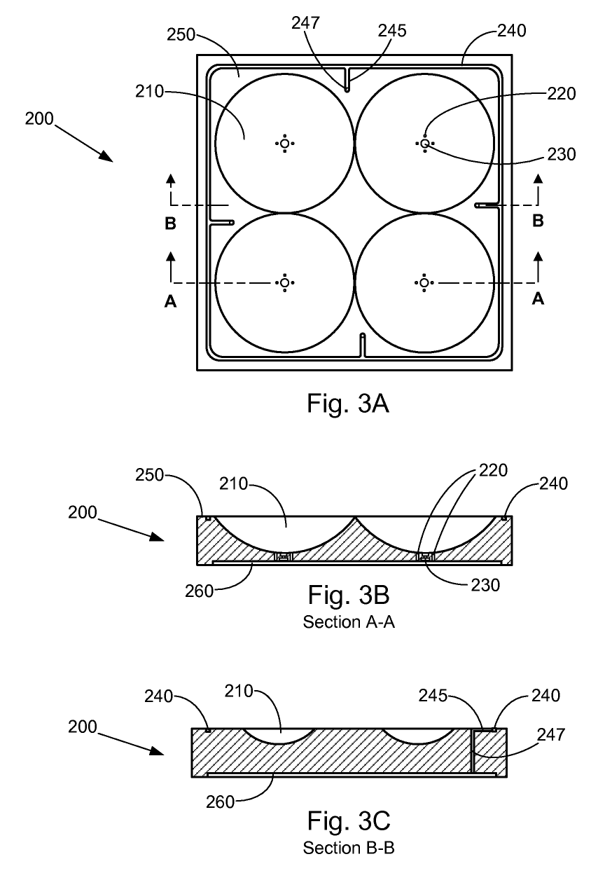

FIG. 3A provides a detailed plan view of the exemplary mold 200 of FIG. 2. Mold 200 may be made of cast iron, stainless steel, ceramic, or other material having suitable properties, such as a compatible thermal expansion coefficient and surface release characteristics, for working with glass. In this exemplary embodiment, cavities 210 are in contact with each other; however, cavities 210 may also be positioned apart from each other. Each of the cavities 210 has vacuum ports 220 surrounding a tooling hole 230. While four vacuum ports 220 are depicted in each cavity 210, fewer or more than four may be used. Having multiple vacuum ports 220 of a small size rather than one port of a larger size allows sufficient vacuum to be achieved while reducing the likelihood of glass from being deformed or marked by the vacuum ports 220 during the slumping process.

Still continuing with FIG. 3A, a vacuum channel 240 is formed in a top surface 250 of mold 200, with channel legs 245 extending from channel 240 and terminating in vacuum ports 247. Top surface 250 incorporates planar areas which are not occupied by cavities 210. Note that vacuum ports 220 and 247 are drawn proportionally larger than necessary for clarity. In the cross-sectional view of section A-A shown in FIG. 3B, vacuum ports 220 are seen to extend from the cavities 210 to a recessed area 260 in the bottom of mold 200. An application of vacuum to recessed area 260, as will be described later, becomes transmitted to cavities 210 through vacuum ports 220 and assists in conforming glass precisely to cavities 210. Recessed area 260 also is in communication with channel 240 in top surface 250 of mold 200. Thus, the present invention applies a vacuum force to the top surface of a mold, in areas outside of the shaping cavities.

As seen in the cross-sectional view of section B-B provided in FIG. 3C, channel 240 connects to channel legs 245, which then connects to recessed area 260 through vacuum ports 247. The resulting negative pressure provided to top surface 250, at the various locations of channel 240 and channel legs 245, advantageously holds the peripheries of a glass sheet in place during forming. Thus, warping is prevented, and multiple accurately-formed parts may be produced within cavities 210. Furthermore, having the edges of a glass sheet held in place during slumping allows a wide range of aspect ratios, defined as the width to the depth of a part, to be achieved. For example, an aspect ratio of up to 1:1 is possible. Mold 200 enables glass parts of a relatively large size, such as on the order of six inches square or more, to be fabricated with high precision.

Note that while the embodiment of FIG. 3A employs a vacuum channel applied approximately around the perimeter of mold 200, other embodiments are possible. For example, multiple discrete vacuum ports may be utilized instead of a continuous channel. In another embodiment, vacuum channel 240 may follow a non-linear path, such as forming a clover-leaf path surrounding the outline of cavities 210. Furthermore, depending on the specific geometry of mold 200 and of cavities 210, vacuum ports may be added between cavities 210, such as in the center of mold 200. The specific number and dimensions of the various vacuum features are dependent upon each mold design and size, particularly the geometry of top surface 250.

An additional feature of mold 200 in FIGS. 3A and 3B is tooling hole 230. As depicted in FIG. 3B, tooling hole 230 is a through-hole in the bottom of cavity 210 into which a mold pin or other tooling piece may be inserted for forming a fiducial feature in the glass part. A fiducial feature, such as an indentation or linear marking, may serve as a datum point during subsequent processing of the part, such as for centering a curved mirror during cutting, or orienting a part for assembly. Fiducial features may also be created by machining protrusions or indentations directly into the mold 200. Moreover, fiducial features may be positioned elsewhere within each cavity 210 or in top surface 250. A fiducial feature in top surface 250 may be useful, for instance, to serve as a registration marking for a finished glass sheet which is to be used in its entirety as a one-piece panel.

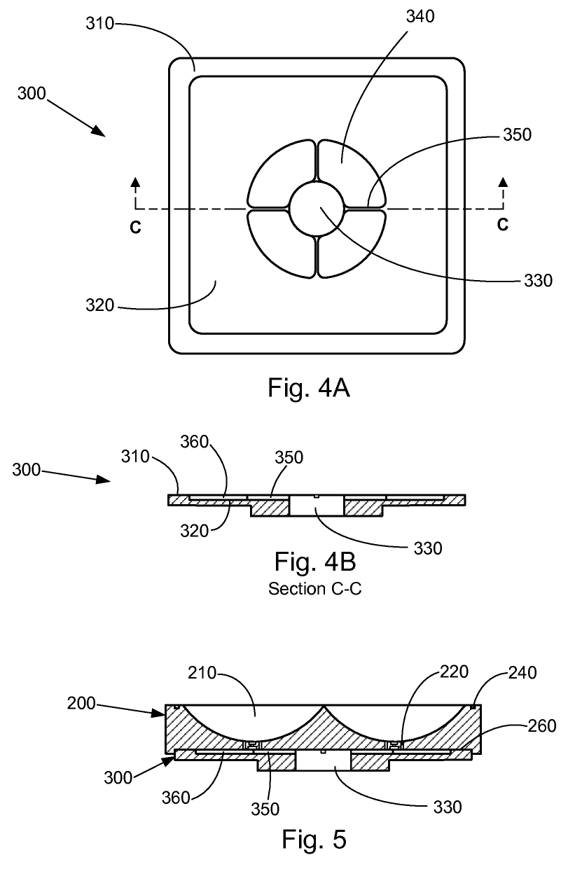

FIGS. 4A and 4B show an exemplary base 300 to be used with mold 200. The use of mold 200 with a separate base 300 facilitates machining of the various features used to apply vacuum to mold 200. The plan view of FIG. 4A shows base 300 as including a lip 310, a main surface 320, an inlet port 330, and a raised platform 340 through which inlet channels 350 are formed. Section C-C, shown in the cross-sectional view of FIG. 4B, illustrates the connection from inlet port 330 to inlet channels 350, and to the recessed area 360 formed by main surface 320 and lip 310. Raised platform 340 may take on geometries other than the circular embodiment with four symmetrically spaced inlet channels 350 shown in FIG. 4A. Alternative configurations, such as unevenly spaced inlet channels 350 or a polygonal raised platform 340, may be utilized as appropriate for various mold geometries and for varying placements of vacuum ports 220 and 247 within mold 200.

The mold 200 and base 300 are viewed together in FIG. 5, which combines the cross-sectional views of FIGS. 3B and 4B taken through the centers of mold 200 and base 300, respectively. From FIG. 5, it can be seen that base 300 fits into recessed area 260 of mold 200. Mold 200 and base 300 may be secured together by means (not shown) such as screws, clamps, pins, or the like, and may additionally incorporate sealing means such as gaskets or sealants. In some cases the weight of mold 200 is sufficient when combined with accurate machining to provide adequate sealing to achieve required vacuum pressure. Vacuum is applied by attaching a negative pressure source to inlet port 330 by mechanisms known in the art. Vacuum is consequently applied to cavities 210 through vacuum ports 220 which are in communication with inlet channels 350. Similarly, vacuum is pulled within channel 240 since vacuum ports 247 of FIG. 3C are in communication with recessed area 360 of base 300 in FIG. 5.

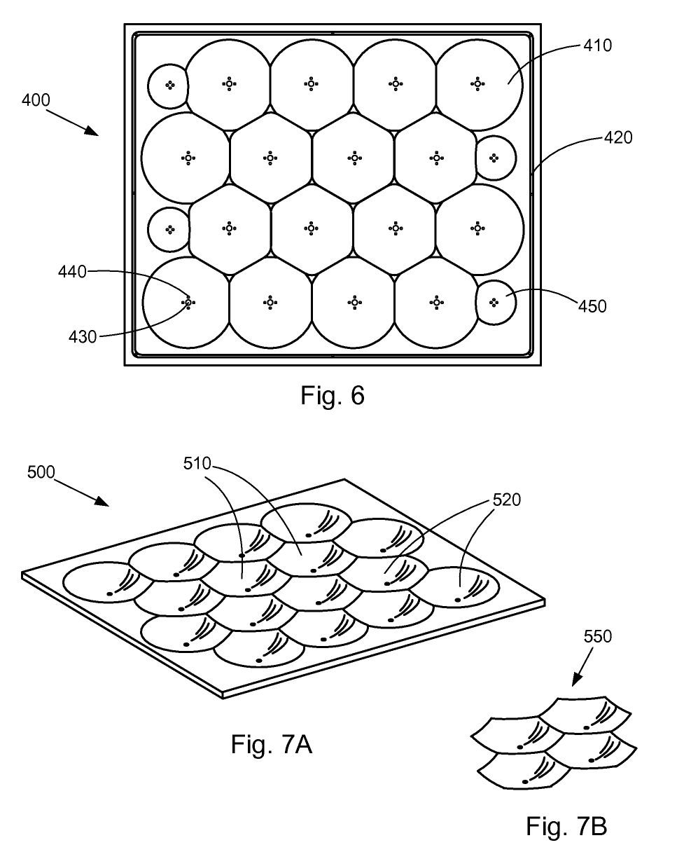

Another embodiment of the present invention is presented in FIG. 6. In this plan view, a mold 400 incorporates an array of sixteen cavities 410 which are arranged to form an array of concave parts having substantially hexagonal perimeters. In one exemplary embodiment, mold 400 may accommodate a glass sheet larger than ten square feet. Mold 400 includes a vacuum channel 420, tooling holes 430, and vacuum ports 440, all similar to mold 200 of FIG. 3A. However, mold 400 additionally includes novel stiffening members 450, which are concavities smaller than the cavities 410 for shaping glass. Because cavities 410 are arranged in an offset manner in mold 400, the relatively large planar areas which would result if stiffening members 450 were not present can result in a level of warping that cannot be overcome simply by applying vacuum ports, such as the exemplary channel legs 245 of FIG. 3A. The concavities formed by stiffening members 450 help stabilize and stiffen unused areas of a glass sheet and thus prevent warping. This is particularly important when forming large features in the glass that by design and size leave significant unused portions of the flat glass sheet. The unused portions of the sheet tend to warp due to changing tension and compression characteristics of the glass when exposed to rapid changes in temperature inherent in the process. By adding stiffening members 450 to the glass, stress-induced warp is limited due to the rigidity of the stiffening members 450 themselves. Stiffening members 450 utilize vacuum ports 440 just as cavities 410 do for conforming glass to their shape. Stiffening members 450 may have geometries different than the circular bowls depicted in FIG. 6, such as elliptical or trough-shaped depressions as determined by the layout of a particular mold design.

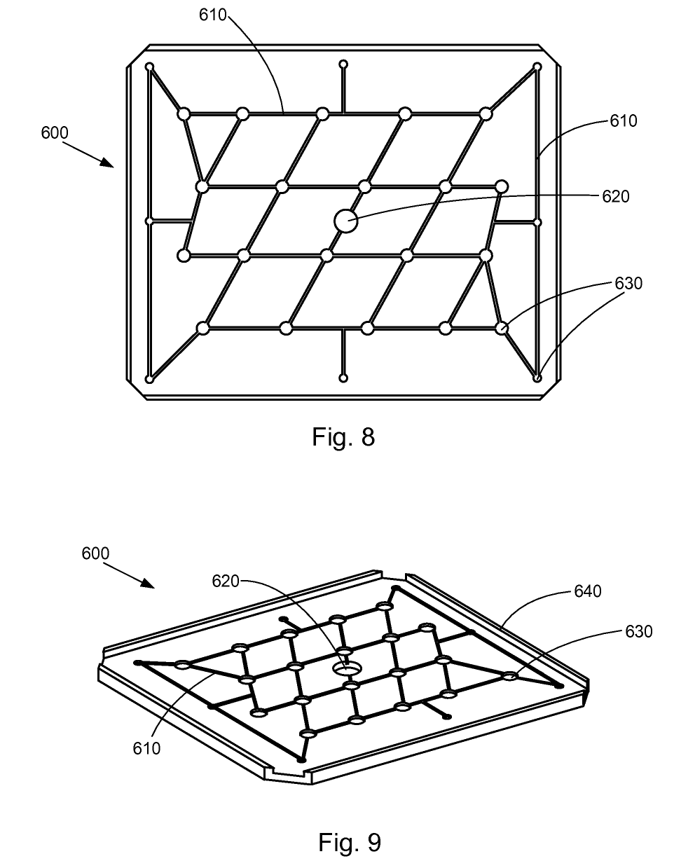

Mold 400 may be used, for example, to create a monolithic mirror array 500 as in FIG. 7A, shown without stiffening members for clarity. Mirror array 500 advantageously has the option of being cut into individual mirrors, into monolithic partial arrays, or being used as a full panel. Cutting may be performed by conventional methods including water jets, lasers, and scoring. In the embodiment of FIG. 7A in which hexagonal mirrors are formed, central mirrors 510 are shaped into complete hexagons by the mold 400 while edge mirrors 520 may undergo subsequent cutting to form a fully hexagonal shape. An exemplary partial array 550 cut from mirror array 500 is shown in FIG. 7B. While four mirrors are depicted in partial array 550, any number of mirrors may be incorporated. Having multiple mirrors already attached and aligned together as in partial array 550 can streamline or eliminate subsequent assembly steps involved with manufacturing a solar concentrator array, thus greatly reducing cost.

FIG. 8 is a plan view of an exemplary mold base 600 which may be used with mold 400 of FIG. 6. Base 600 depicts an alternative configuration for achieving a vacuum system than that described previously. While base 300 of FIGS. 4A and 4B has a large recessed area 360 connected to a few inlet channels 350, base 600 of FIG. 8 utilizes a full network of vacuum channels 610 to transmit negative pressure supplied through an inlet port 620. Relief holes 630 transmit vacuum to mold 400 of FIG. 6 by aligning with vacuum channel 420 and vacuum ports 440. FIG. 9 provides a perspective view of base 600, additionally showing a lip 640 into which mold 400 may be seated.

Different vacuum network configurations are possible other than those shown for base 300 of FIG. 4A and base 600 of FIGS. 8 and 9. The various vacuum channels and recessed areas described herein may be arranged in various combinations to adequately distribute the necessary negative pressure. Alternatively, tubing components may be incorporated into a base as a supplement to or in place of channels machined into a base. In yet another embodiment, a mold may be used without a base. Instead, connectors may be incorporated directly into bottom of the mold so that individual vacuum lines may be connected to each vacuum port.

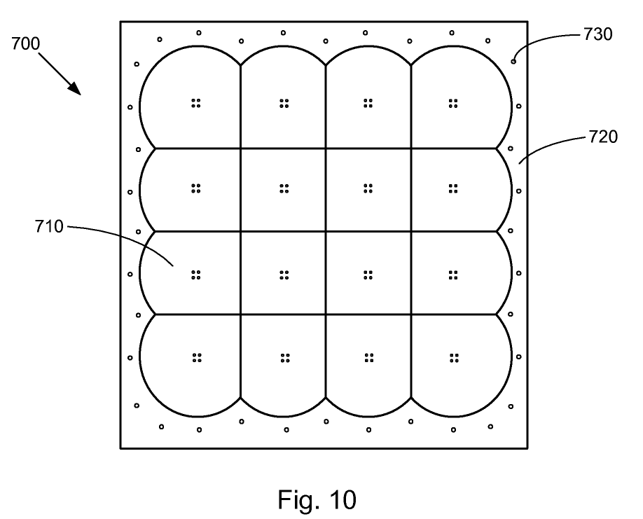

FIG. 10 shows a yet further embodiment of the present invention, in which a mold 700 incorporates an array of orthogonally arranged cavities 710. Cavities 710 are adjoining, resulting in substantially square perimeters for cavities 710. In this embodiment of FIG. 10, the previously described tooling holes are omitted, and stiffening members are not utilized due to the substantially uniform width of top surface 720 around the perimeter of mold 700. Vacuum ports 730 for top surface 720 are discrete ports rather than a continuous channel as used in previous mold embodiments, and are positioned in a staggered fashion.

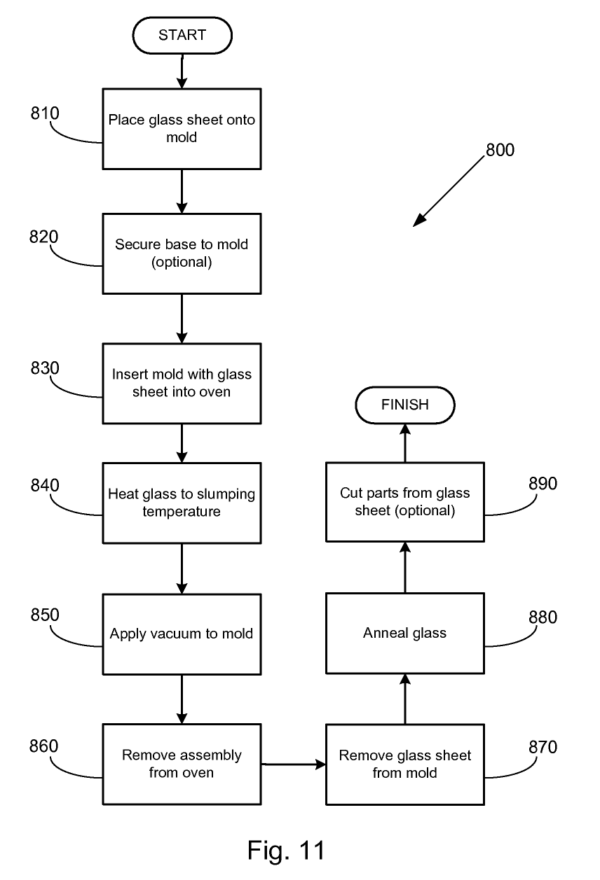

Now focusing on the slumping process, an exemplary process of the present invention is described in flowchart 800 of FIG. 11. Flowchart 800 begins in step 810 with placing a glass sheet onto a mold. Note that prior to step 810, preparatory steps such as cutting the glass sheet to size and cleaning it may be performed. If a base is used, the base is secured to the mold in step 820. The glass sheet, mold, and base are then inserted into an oven in step 830, and in step 840 the assembly is heated to sufficient temperature to soften the glass. Glass slumping temperatures are commonly in the range of, for example, 1000 to 1300° F. for soda lime glass and 1000 to 2000° F. for various types of borosilicate glasses. Standard ovens known in the glass forming industry, sized large enough to accommodate the desired multi-cavity mold, may be utilized. To achieve even heating over the large surface of the mold, it is desirable to use direct thermal irradiance. Once the glass has reached its target temperature, vacuum is applied to the mold in step 850, which prevents warping of unused portions of the glass sheet while also assisting the glass to draw into and conform to the mold cavities. The heating and shaping of steps 840 and 850 may take a cycle time of, for example, 4 to 15 minutes, depending on the size of the mold, glass and oven. Thus, forming multiple glass parts with a single slumping run rather than producing them one at a time can dramatically increase production rates.

Once the glass has been shaped, the assembly is removed from the oven in step 860, and then the glass is removed from the mold in step 870. The glass is annealed in step 880 using conventional furnaces or other methods. Finally, individual parts or partial arrays may optionally be cut from the glass sheet in step 890, or the full glass sheet may be used as a complete panel. The glass parts are then ready for downstream processing steps, such as performing secondary cutting operations (e.g., truncating the sides of edge mirrors 520 in FIG. 7A), cleaning, and applying mirror coatings.

Although embodiments of the invention have been discussed primarily with respect to specific embodiments thereof, other variations are possible. For example, while the invention has been described with respect to solar concentrator mirrors, the invention may be applied to the fabrication of any glass parts which are suitable for a slumping process, such as those for general or advanced lighting purposes. Steps can be added to, taken from or modified from the steps in this specification without deviating from the scope of the invention. In general, any flowcharts presented are only intended to indicate one possible sequence of basic operations to achieve a function, and many variations are possible.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention. Thus, it is intended that the present subject matter covers such modifications and variations as come within the scope of the appended claims and their equivalents.

What is claimed is:

1. A method of shaping a glass sheet, said method comprising:
placing a glass sheet onto a mold, said mold comprising two cavities and a top surface, wherein a primary vacuum port is located in said top surface and a secondary vacuum port is located in each of said cavities;
inserting said glass sheet and said mold into an oven;
heating said glass sheet and said mold in said oven to a temperature sufficient to cause slumping of said glass sheet into said cavities;
applying vacuum through said first vacuum port and said secondary vacuum ports;
removing said glass sheet and said mold from said oven; and
annealing said glass sheet.

2. The method of shaping a glass sheet of claim 1, further comprising the step of separating said glass sheet into individual parts formed by each of said cavities.

3. The method of shaping a glass sheet of claim 1, further comprising the step of separating a monolithic array of parts from said glass sheet, said monolithic array of parts being defined by an array of said cavities.

4. The method of shaping a glass sheet of claim 1, wherein said glass sheet has a surface area greater than one square foot.

5. The method of shaping a glass sheet of claim 1, further comprising the step of coupling a base to said mold, wherein said base comprises an inlet port for a vacuum source.

6. The method of shaping a glass sheet of claim 1, wherein said primary vacuum port comprises a channel located in said top surface.

7. The method of shaping a glass sheet of claim 1, wherein said secondary vacuum port comprises a plurality of discrete vacuum ports in each of said cavities.

8. The method of shaping a glass sheet of claim 1, wherein said mold further comprises a stiffening member formed in said top surface, and wherein a tertiary vacuum port is located in said stiffening member.

9. A monolithic glass array created by a process comprising the step of slumping glass into a mold, said mold having a top surface and a plurality of cavities;
wherein a primary vacuum port is located in said top surface of said mold and a secondary vacuum port is located in each of said cavities; and
wherein vacuum is applied to said primary vacuum port and said secondary vacuum ports during said slumping.

10. The monolithic glass array of claim 9, wherein said cavities form an array of mirrors for a solar concentrator array.

11. The monolithic glass array of claim 9, wherein said process further comprises the step of separating said monolithic glass array into partial arrays.

12. An apparatus for forming glass, comprising:
a mold;
a plurality of cavities formed in said mold, each of said cavities defining a shape to which a glass sheet is to be molded;
a top surface of said mold, said top surface comprising planar areas unoccupied by said plurality of cavities;
a primary vacuum port located in said top surface; and
a plurality of secondary vacuum ports, wherein one secondary vacuum port is located in each of said cavities.

13. The apparatus for forming glass of claim 12, wherein said mold is made of cast iron.

14. The apparatus for forming glass of claim 12, wherein said mold is capable of forming a glass sheet greater than one square foot in size.

15. The apparatus for forming glass of claim 12, wherein said primary vacuum port comprises a continuous vacuum channel surrounding said plurality of said cavities.

16. The apparatus for forming glass of claim 12, further comprising a base having an inlet port for a vacuum source, wherein said inlet port is in communication with said primary vacuum port and said plurality of secondary vacuum ports.

17. The apparatus for forming glass of claim 12, further comprising a stiffening member formed in said top surface, wherein a tertiary vacuum port is located in said stiffening member.

18. The apparatus for forming glass of claim 12, wherein said plurality of cavities are adjoining and arranged in an array.

19. The apparatus for forming glass of claim 18, wherein said plurality of cavities forms a substantially hexagonal array.

20. The apparatus for forming glass of claim 18, wherein said plurality of cavities forms a substantially square array.
